(19) United States
(12) Patent Application Publication
(10) Pub. No.: US 2018/0034292 A1
(43) Pub. Date: Feb. 1, 2018

(54) PORTABLE POWER SOURCE WITH REMOVAL WARNING FUNCTION

(71) Applicants: SHENZHEN FUTAIHONG PRECISION INDUSTRY CO., LTD., Shenzhen (CN); FIH (HONG KONG) LIMITED, Kowloon (HK)

(72) Inventors: HUI YIN, Shenzhen (CN); CHUN-WEI PAN, New Taipei (TW); CHIA- SHAN YU, New Taipei (TW); GUO-HUA FENG, Shenzhen (CN); CHEN-HSUAN HO, New Taipei (TW)

(21) Appl. No.: 15/660,959

(22) Filed: Jul. 27, 2017

(30) Foreign Application Priority Data
Jul. 27, 2016 (CN) 201620797474.8

(51) Int. Cl. H02J 7/00; G08B 21/18

(52) U.S. Cl. CPC H02J 7/0036; H02J 7/0045; H02J 7/0047; G08B 21/182; H02J 2007/0096; H02J 2007/005

(57) ABSTRACT

A portable power source with removal warning function includes a large battery, a interface, a charging and discharging circuit, a wireless communication module, an alarm module; and a processor. The interface can connect to one of an external power supply and battery (ED battery) of an electronic device. The charging and discharging circuit can charge and allow discharge of the large battery and the charging of an ED battery. The wireless communication module can communicate between the portable power source and the electronic device. The processor can determine whether a distance between the portable power source and the electronic device is within or beyond a preset distance and control the alarm module to sound if the distance is beyond the preset distance.

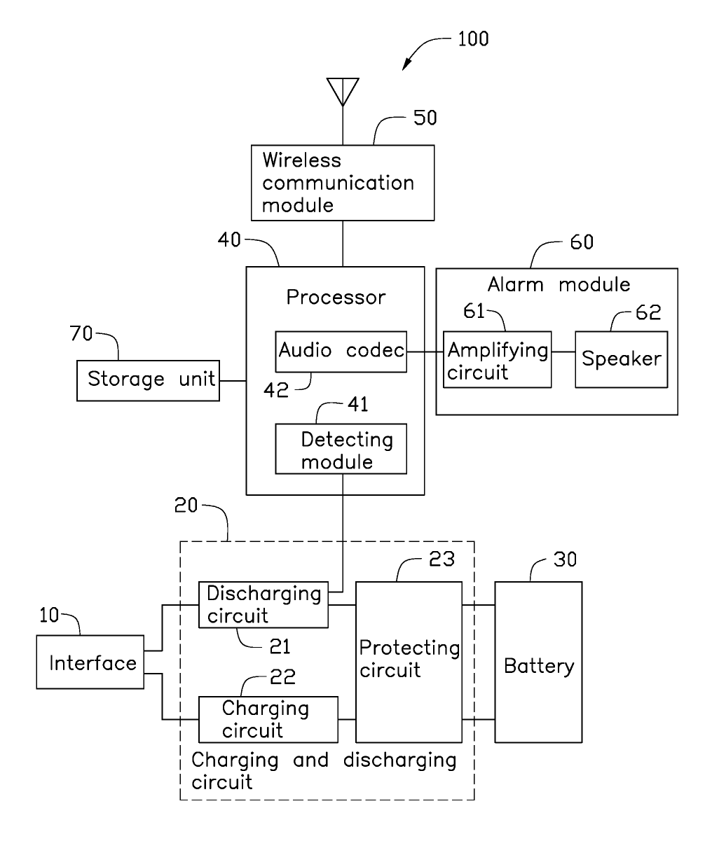

### CROSS-REFERENCE TO RELATED DISCLOSURES

This disclosure claims priority to Chinese Patent Application No. 201620797474.8 filed on Jun. 27, 2016, the contents of which are incorporated by reference herein.

### FIELD

The disclosure generally relates to security, and particularly to a portable power source having an removal warning function.

### BACKGROUND

Electronic power charged and stored into an electronic device such as a mobile phone is limited, therefore a user commonly connects and uses an independent and valuable portable power source to charge the electronic device anytime and anywhere.

### BRIEF DESCRIPTION OF THE DRAWING

Many aspects of the present disclosure can be better understood with reference to the drawing. The components are not necessarily drawn to scale, the emphasis instead being placed upon clearly illustrating the principles of the disclosure.

The FIGURE is a block diagram of an exemplary embodiment of a portable power source.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The FIGURE shows an exemplary embodiment of a portable power source. The portable power source 100 includes a interface 10, a charging and discharging circuit 20, a battery 30, a processor 40, a wireless communication module 50, and an alarm module 60. The interface 10, the charging and discharging circuit 40, and the battery 30 are electronically connected and form a charging unit. The wireless communication module 50 and the alarm module 60 are electronically connected to the processor 40 and form an removal warning unit.

The interface 10 is configured to connect to an external power supply (not shown), and charge the battery 30 through the charging and discharging circuit 20. The interface 10 may also connect to an electronic device (not shown), and control the battery 30 via the charging and discharging circuit 20, thereby charging a battery (“ED battery”, but not shown) of the electronic device. The wireless communication module 50 is configured to establish a wireless communication connection between the portable power source 100 and the electronic device. The processor 40 determines whether a distance between the portable power source 100 and the electronic device is within or beyond a preset distance according to a state of the wireless communication connection, and controls the alarm module 60 to warn a user if the distance is beyond the preset distance. Security of the portable power source 100 and the electronic device is thereby enhanced.

In this exemplary embodiment, when the distance between the portable power source 100 and the electronic device is beyond the preset distance, the wireless communication connection is disconnected. Therefore, when the processor 40 detects that the wireless communication connection is disconnected, the processor 40 determines that the distance between the portable power source 100 and the electronic device is beyond the preset distance.

In this exemplary embodiment, the charging and discharging circuit 20 includes a discharging circuit 21 and a charging circuit 22. The discharging circuit 21 is electronically connected between the interface 10 and the battery 30. The discharging circuit 21 is configured to allow the battery 30 to supply charge to the ED battery when the interface 10 is connected to the electronic device, thereby charging the electronic device. The charging circuit 22 is electronically connected between the interface 10 and the battery 30. The charging circuit 22 is configured to charge the battery 30 from an external power supply so that the battery 30 can store power when the interface 10 is electronically connected to the external power supply.

In this exemplary embodiment, the discharging circuit 221 is also electronically connected to the processor 40 to provide power to the processor 40, the wireless communication module 50, and the alarm module 60 of the removal warning unit. The continuous supply of power to the removal warning unit is preset as a first priority to avoid deactivation of the removal warning unit due to lack of power.

In other embodiments, the charging and discharging circuit 20 further includes a protecting circuit 23. One end of the protecting circuit 23 is electronically connected to the discharging circuit 21 and the charging circuit 22. Another end of the protecting circuit 23 is electronically connected to the battery 30. The protecting circuit 23 is configured to protect the battery 30 from over-current or over-voltage during charging and discharging.

In other embodiments, the processor 40 further includes a detecting module 41. The detecting module 41 is electronically connected to the charging and discharging circuit 20, and configured to detect a remaining power level of the battery 30. The processor 40 can display the power level and charging state (e.g. normally being charged, charging completed, etc.) and charging progress (e.g. charging ED battery to 30%, charging completion, etc.) through the electronic device.

In other embodiments, the processor 40 is configured to set the preset distance and an alarm mode (e.g. alarm/warning volume, and type of alarm) through the electronic device.

In other embodiments, the portable power source 100 further includes a storage unit 70 configured to store the above settings (i.e. the preset distance and the alarm mode).

In other embodiments, the processor 40 is configured to trigger the electronic device to issue its own warning through the wireless communication module 50 when the distance between the portable power source 100 and the electronic device reaches to the preset distance before loosing connection, thereby serving as a two-way reminder to the user to avoid losing the portable power source 100.

In this exemplary embodiment, the alarm module 60 includes an amplifying circuit 61 and a speaker 62. The processor 40 further includes an audio codec 42. The audio codec 42 is electronically connected to the speaker 62 by the amplifying circuit 61. When the distance between the portable power source 100 and the electronic device is beyond the preset distance, the processor 40 sends a warning signal to the speaker 62 by the audio codec 42. The amplifying circuit 61 is configured to amplify the warning signal or sound.

The portable power source 100 both has a charging function and removal warning function, which can charge the ED battery of an electronic device and also can alarm the user to avoid losing or inadvertently carrying off the portable power source 100 when the distance between the portable power source 100 and the electronic device is beyond the preset distance.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A portable power source comprising:
a battery;
an interface, the interface configured to connect to one of an external power supply and an electronic device;
a charging and discharging circuit, electronically connected to the battery and the interface, and configured to charge and discharge the battery;
a wireless communication module, the wireless communication module configured to establish a wireless communication connection between the portable power source and the electronic device;
an alarm module; and
a processor, the processor configured to determine whether a distance between the portable power source and the electronic device is beyond a preset distance according to a connection or disconnection state of the wireless communication connection, and control the alarm module to alarm if the distance is beyond the preset distance.

2. The portable power source of claim 1, wherein when the processor detects that the wireless communication connection is disconnected, the processor determines that the distance between the portable power source and the electronic device is beyond the preset distance.

3. The portable power source of claim 1, wherein the processor further comprises a detecting module electronically connected to the charging and discharging circuit, and configured to detect a capacity of the battery, the processor displays the capacity and charging states and charging progress of the battery through the electronic device.

4. The portable power source of claim 1, wherein the processor is configured to set the preset distance and the alarm module through the electronic device.

5. The portable power source of claim 4, wherein the portable power source further comprises a storage unit configured to store the preset distance and an alarm mode, the alarm mode comprises an alarm volume and an alarm sound type.

6. The portable power source of claim 4, wherein the alarm module comprises an amplifying circuit and a speaker, the processor further comprises an audio codec, the audio codec is electronically connected to the speaker by the amplifying circuit, when the distance between the portable power source and the electronic device is beyond the preset distance, the processor sends an alarm sound signal to the speaker by the audio codec, the amplifying circuit amplifies the alarm sound signal.

7. The portable power source of claim 1, wherein the charging and discharging circuit comprises a discharging circuit and a charging circuit, the discharging circuit is electronically connected between the interface and the battery, the discharging circuit is configured to discharge from the battery to the electronic device when the interface is connected to the electronic device, thereby charging the electronic device; the charging circuit is electronically connected between the interface and the battery, the charging circuit is configured to charge the battery so that the battery stores the electronic power when the interface is electronically connected to the external power supply.

8. The portable power source of claim 7, wherein the charging and discharging circuit further comprises a charging protecting circuit, one end of the charging protecting circuit is electronically connected to the discharging circuit and the charging circuit, another end of the charging protecting circuit is electronically connected to the battery, the charging protecting circuits configured to protect the battery from over-current or over-voltage during charging or discharging.

9. The portable power source of claim 7, wherein the discharging circuit is also electronically connected to the processor to provide power supply to the processor, the wireless communication module, and the alarm module of the anti-theft unit.

10. A portable power source comprising:
a battery;
a interface, configured to connect to one of an external power supply and an electronic device;
a charging and discharging circuit, electronically between the battery and the interface, and configured to charge and discharge the battery;
a wireless communication module, configured to establish a wireless communication connection between the portable power source and the electronic device;
an alarm module; and
a processor, configured to determine whether a distance between the portable power source and the electronic device is beyond a preset distance according to a connection or disconnection state of the wireless communication connection, control the alarm module to alarm, and trigger the electronic device to issue its own warning through the wireless communication module if the distance reaches to the preset distance.

11. The portable power source of claim 10, wherein when the processor detects that the wireless communication connection is disconnected, the processor determines that the distance between the portable power source and the electronic device is beyond the preset distance.

12. The portable power source of claim 10, wherein the processor further comprises a detecting module electronically connected to the charging and discharging circuit, and configured to detect a capacity of the battery, the processor displays the capacity and charging states and charging progress of the battery through the electronic device.

13. The portable power source of claim 10, wherein the processor is configured to set the preset distance and the alarm module through the electronic device.

14. The portable power source of claim 13, wherein the portable power source further comprises a storage unit configured to store the preset distance and the alarm mode, the alarm mode comprises an alarm volume and an alarm sound type.
